(19) United States
(12) Patent Application Publication
(10) Pub. No.: US 2025/0298451 A1
(43) Pub. Date: Sep. 25, 2025

(54) POWER SUPPLY MANAGEMENT CIRCUIT, MEMORY SYSTEM, AND POWER SUPPLY MANAGEMENT METHOD

(71) Applicant: Kioxia Corporation, Tokyo (JP)

(72) Inventor: Keita OZAWA, Yokohama Kanagawa (JP)

(21) Appl. No.: 19/061,216

(22) Filed: Feb. 24, 2025

(30) Foreign Application Priority Data
Mar. 21, 2024 (JP) 2024-045413

(51) Int. Cl. G06F 1/26; G06F 1/30

(52) U.S. Cl. CPC G06F 1/263; G06F 1/30

(57) ABSTRACT

A power supply management circuit includes a terminal connectable to a plurality of power storage elements via a plurality of switches, respectively, a measurement circuit, and a step-up/down circuit. The power supply management circuit is configured to obtain a total capacity of a first group of the power storage elements that are in connected state, and obtain a total capacity of a second group of the power storage elements that are in connected state. The power supply management circuit is configured to obtain a capacity of a first power storage element among the plurality of power storage elements based on a difference between the total capacity of the first group of the power storage elements and the total capacity of the second group of the power storage elements.

### CROSS-REFERENCE TO RELATED APPLICATION

This application is based upon and claims the benefit of priority from Japanese Patent Application No. 2024-045413, filed Mar. 21, 2024, the entire contents of which are incorporated herein by reference.

### FIELD

Embodiments described herein relate generally to a power supply management circuit, a memory system, and a power supply management method.

### BACKGROUND

A power supply management circuit that controls charging and discharging of a connected power storage device is known. Such a power supply management circuit can be used in a memory system including a volatile memory. Such a memory system charges the power storage device while an external power is being supplied. In addition, the memory system can operate using electrical power obtained by discharging of the power storage device during an interruption of the external power. When a plurality of power storage devices are used, it is desirable to appropriately control the plurality of power storage devices.

### BRIEF DESCRIPTION OF THE DRAWINGS

FIG. 1 is a block diagram illustrating a configuration of a memory system according to an embodiment;

FIG. 2 is a circuit diagram illustrating a configuration of a switching circuit according to the embodiment;

FIG. 3 is a circuit diagram illustrating an example of the configuration of the switching circuit according to the embodiment;

FIGS. 4A to 4D are circuit diagrams illustrating an operation of the switching circuit during capacitance measurement, respectively, according to the embodiment;

FIG. 5 is a waveform diagram illustrating an operation of the switching circuit and a power supply management circuit according to the embodiment;

FIGS. 6A to 6D are circuit diagrams illustrating an operation of the switching circuit during discharging, respectively, according to the embodiment; and

FIG. 7 is a block diagram illustrating a configuration of a memory system according to a modification of the embodiment.

### DETAILED DESCRIPTION

Embodiments provide a power supply management circuit, a memory system, and a power supply management method that can appropriately control a plurality of power storage elements.

In general, according to an embodiment, a power supply management circuit includes a terminal connectable to a plurality of power storage elements via a plurality of switches, respectively, a measurement circuit configured to measure a voltage of the terminal, and a step-up/down circuit connected to the plurality of power storage elements via the terminal. The power supply management circuit is configured to cause a first group of the power storage elements to be in a connected state by turning on the corresponding one or more of the switches, cause the step-up/down circuit to charge the first group of the power storage elements, cause the measurement circuit to measure a first voltage difference while the first group of the power storage elements are discharged at a first constant current, and obtain a total capacity of the first group of the power storage elements based on the first constant current and the first voltage difference. The power supply management circuit is configured to cause a second group of the power storage elements to be in a connected state by turning on the corresponding one or more of the switches, cause the step-up/down circuit to charge the second group of the power storage elements, cause the measurement circuit to measure a second voltage difference while the second group of the power storage elements are discharged at a second constant current, and obtain a total capacity of the second group of the power storage elements based on the second constant current and the second voltage difference. The power supply management circuit is configured to obtain a capacity of a first power storage element among the plurality of power storage elements based on a difference between the total capacity of the first group of the power storage elements and the total capacity of the second group of the power storage elements.

Hereinafter, a power supply management circuit, a memory system, and a power supply management method according to an embodiment will be described in detail with reference to the accompanying drawings. The present disclosure is not limited to the embodiment.

### Embodiment

A memory system according to an embodiment includes a power supply management circuit. The memory system charges a plurality of power storage elements using the power supply management circuit, and is capable of using charges stored in the plurality of power storage elements as a source of power when power is interrupted to the memory system. In the embodiment to be described below, a technique is employed for appropriately managing operations of the plurality of power storage elements.

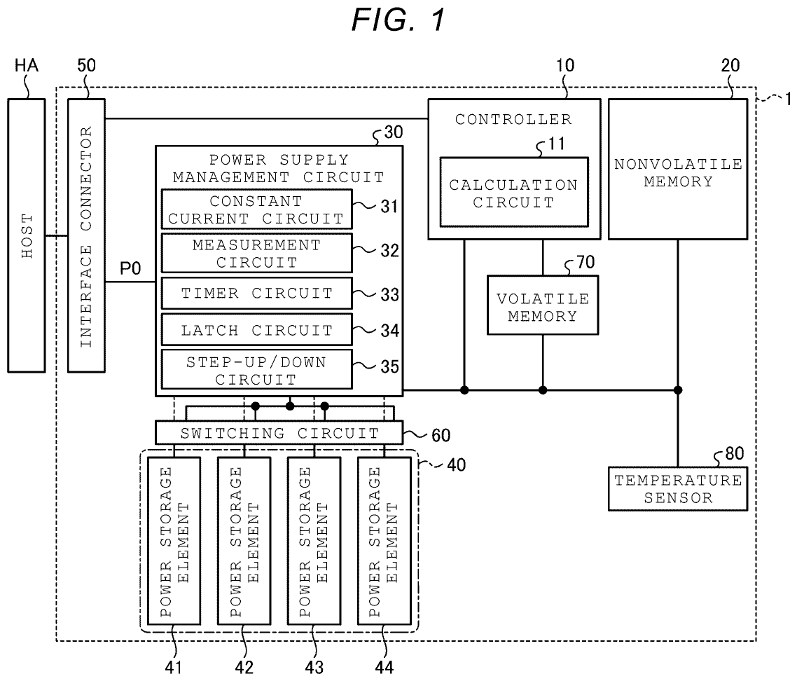

A memory system 1 can be configured as illustrated in FIG. 1. FIG. 1 is a block diagram illustrating a configuration of the memory system 1.

The memory system 1 is capable of being connected to and communicating with a host HA via a communication medium and can function as a storage medium for the host HA. The memory system 1 can include a board and a plurality of electronic components mounted on the board. The memory system 1 may be, for example, a solid state drive (SSD) or a universal flash storage (UFS) device. The communication medium may be a wired communication channel such as a serial cable. The host HA may be: an information processing device such as a personal computer, a server, or a storage box; a mobile phone; an imaging device; a portable terminal such as a tablet computer or a smartphone; a game machine; or an in-vehicle terminal such as a car navigation system, for example.

The memory system 1 includes a controller 10, a nonvolatile memory 20, a power supply management circuit 30, a power storage element group 40, an interface connector 50, a switching circuit 60, a volatile memory 70, and a temperature sensor 80.

The interface connector 50 is a circuit device that is connectable to the host HA. The interface connector 50 can be disposed at, for example, an end of a circuit board. The interface connector 50 includes a power-supply pin and a data pin. The interface connector 50 supplies data received from the host HA via the data pin to the controller 10, and transmits data received from the controller 10 to the host HA via the data pin. The interface connector 50 supplies a power supply voltage received from the host HA via the power-supply pin to the power supply management circuit 30.

The controller 10 is a semiconductor device that controls overall operations of the memory system 1. For example, the controller 10 controls communication between the host HA and the memory system 1. The controller 10 receives commands from the host HA and executes a write operation and a read operation to/from the nonvolatile memory 20. Alternatively, the controller 10 executes an erase operation to erase data stored in the nonvolatile memory 20. The controller 10 controls operations on the nonvolatile memory 20 using the volatile memory 70. Each of functions of the controller 10 may be implemented as the controller 10 executing firmware. Each of the functions of the controller 10 may be implemented by dedicated hardware in the controller 10. The controller 10 can be mounted on the board as a System-on-a-Chip (SoC).

The nonvolatile memory 20 stores data and/or information in a nonvolatile manner. The nonvolatile memory 20 may be, for example, an NAND flash memory. The nonvolatile memory 20 includes a memory cell array in which a plurality of memory cells are arranged in a two-dimensional or three-dimensional matrix configuration. Each of the memory cells can store multiple bits of data using a plurality of page configurations, for example. In the nonvolatile memory 20, data is erased in units of blocks, and data is written and read for each page. The block is configured with a plurality of pages.

The volatile memory 70 temporarily stores data and/or information. The volatile memory 70 may be, for example, an SDRAM, a DRAM, or an SRAM. The volatile memory 70 functions as a buffer during transmission and reception of signals (for example, commands, data, and the like) between the host HA or the nonvolatile memory 20 and the controller 10, or functions as a work area of the controller 10.

The temperature sensor 80 measures a temperature around the memory system 1. The temperature sensor 80 supplies the measured temperature to the power supply management circuit 30. The temperature sensor 80 may supply the measured temperature to the power supply management circuit 30 under the control by the controller 10. The temperature sensor 80 is, for example, an electronic circuit including a thermistor. In this case, the temperature sensor 80 is mounted, for example, at a position near the power storage element group 40 on the board, and is capable of detecting a temperature of air near the power storage element group 40. The temperature sensor 80 may be embedded in the controller 10 or the nonvolatile memory 20.

The power supply management circuit 30 controls the supply of power to respective components (for example, the controller 10, the nonvolatile memory 20, and the volatile memory 70) of the memory system 1. The power supply management circuit 30 can execute a part of a power loss protection (PLP) process. The PLP process is a process for protecting data stored in the memory system 1 when power supplied from the external device (for example, the host HA) to the memory system 1 is lost. In the PLP process, data in the volatile memory 70 is urgently saved to the nonvolatile memory 20 using the power of the power storage element group 40 such that the data in the volatile memory 70 is not lost.

The power supply management circuit 30 is connected to the power storage element group 40 via the switching circuit 60. In preparation for the PLP process, the power supply management circuit 30 controls the switching circuit 60 and controls charging and discharging of the power storage element group 40 via the switching circuit 60. The power supply management circuit 30 can be mounted on the board as a power management IC (PMIC). An internal configuration of the power supply management circuit 30 will be described below.

The power storage element group 40 stores power to be supplied to each component of the memory system 1. The power storage element group 40 includes a plurality of power storage elements 41 to 44. Each of the power storage elements 41 to 44 may be a capacitor or a battery. The capacitor may be an electrolytic capacitor, a stacked capacitor, a tantalum capacitor, an electric double-layer capacitor, a ceramic capacitor, or a polymer capacitor. The battery may be a secondary battery (for example, a lithium ion secondary battery or a nickel-metal hydride battery) or the like.

The switching circuit 60 is connected between the power supply management circuit 30 and the power storage element group 40. Under the control of the power supply management circuit 30, the switching circuit 60 is capable of connecting at least some of the power storage elements 41 to 44 in the power storage element group 40 to the power supply management circuit 30.

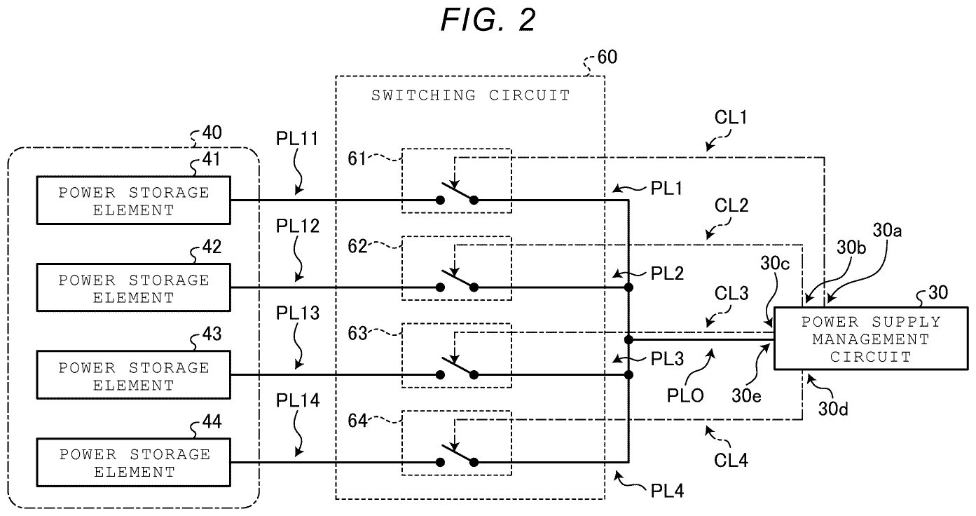

The switching circuit 60 can be configured as illustrated in FIG. 2. FIG. 2 is a circuit diagram illustrating a configuration of the switching circuit 60.

The switching circuit 60 includes a plurality of switches 61 to 64. The plurality of switches 61 to 64 correspond to the plurality of power storage elements 41 to 44, respectively. Each of the switches 61 to 64 is capable of connecting the corresponding power storage element to the power supply management circuit 30. In the example of FIG. 1, the power storage element group 40 includes four power storage elements 41 to 44 and the switching circuit 60 includes four switches 61 to 64, but the number of power storage elements in the power storage element group 40 and the number of switches in the switching circuit 60 may each be 2 to 3, or 5 or more.

The switch 61 has a first end connected to the power storage element 41 via a power supply line PL11. The switch 61 has a second end connected to a power supply terminal 30e of the power supply management circuit 30 via a power supply line PL1 and a common power supply line PL0. The switch 61 has a control terminal connected to a control terminal 30a of the power supply management circuit 30 via a control line CL1. A voltage of a certain potential is output from the power supply terminal 30e of the power supply management circuit 30, which is treated as a power supply voltage in the power supply management circuit 30.

The switch 62 has a first end connected to the power storage element 42 via a power supply line PL12. The switch 62 has a second end connected to the power supply terminal 30e of the power supply management circuit 30 via a power supply line PL2 and the common power supply line PL0. The switch 62 has a control terminal connected to a control terminal 30b of the power supply management circuit 30 via a control line CL2.

The switch 63 has a first end connected to the power storage element 43 via a power supply line PL13. The switch 63 has a second end connected to the power supply terminal 30e of the power supply management circuit 30 via a power supply line PL3 and the common power supply line PL0. The switch 63 has a control terminal connected to a control terminal 30c of the power supply management circuit 30 via a control line CL3.

The switch 64 has a first end connected to the power storage element 44 via a power supply line PL14. The switch 64 has a second end connected to the power supply terminal 30e of the power supply management circuit 30 via a power supply line PL4 and the common power supply line PL0. The switch 64 has a control terminal connected to a control terminal 30d of the power supply management circuit 30 via a control line CL4.

The plurality of switches 61 to 64 are individually controlled to be turned on and off by the power supply management circuit 30. The plurality of switches 61 to 64 may be controlled to be automatically turned on and off by the power supply management circuit 30, or may be turned on and off by the controller 10 via the power supply management circuit 30. The plurality of switches 61 to 64 are not limited to specific elements as long as being capable of switching a corresponding connection between the power storage element group 40 and the switching circuit 60 between a connected state and a disconnected state. The plurality of switches 61 to 64 are an example of a switching circuit.

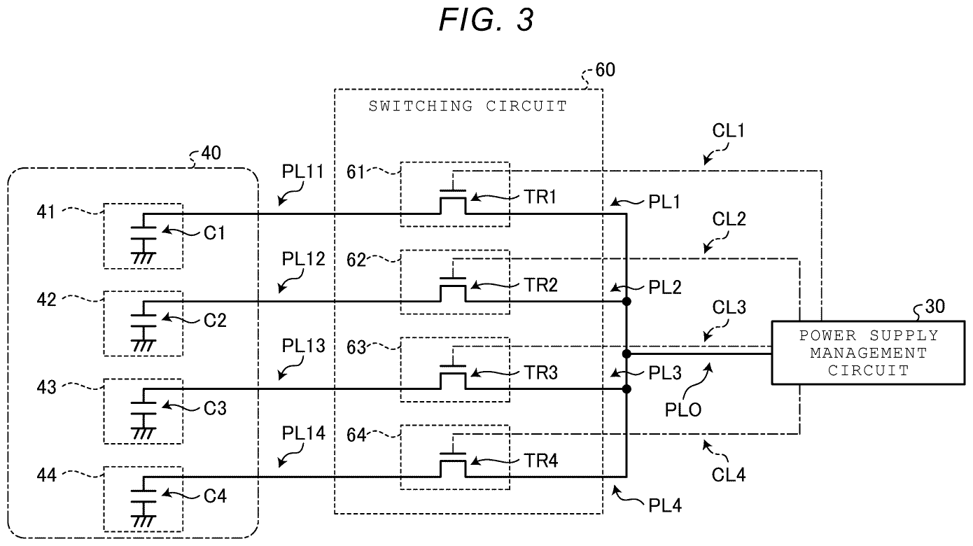

As an example, the switches 61 to 64 in the switching circuit 60 may be transistors TR1 to TR4, respectively, as illustrated in FIG. 3. The power storage elements 41 to 44 may be capacitors C1 to C4, respectively.

The transistor TR1 has a source connected to the power storage element 41 via the power supply line PL11. The transistor TR1 has a drain connected to the power supply terminal 30e of the power supply management circuit 30 via the power supply line PL1 and the common power supply line PL0. The transistor TR1 has a gate connected to the control terminal 30a of the power supply management circuit 30 via the control line CL1.

The transistor TR2 has a source connected to the power storage element 42 via the power supply line PL12. The transistor TR2 has a drain connected to the power supply terminal 30e of the power supply management circuit 30 via the power supply line PL2 and the common power supply line PL0. The transistor TR2 has a gate connected to the control terminal 30b of the power supply management circuit 30 via the control line CL2.

The transistor TR3 has a source connected to the power storage element 43 via the power supply line PL13. The transistor TR3 has a drain connected to the power supply terminal 30e of the power supply management circuit 30 via the power supply line PL3 and the common power supply line PL0. The transistor TR3 has a gate connected to the control terminal 30c of the power supply management circuit 30 via the control line CL3.

The transistor TR4 has a source connected to the power storage element 44 via the power supply line PL14. The transistor TR4 has a drain connected to the power supply terminal 30e of the power supply management circuit 30 via the power supply line PL4 and the common power supply line PL0. The transistor TR4 has a gate connected to the control terminal 30d of the power supply management circuit 30 via the control line CL4.

The power supply management circuit 30 illustrated in FIG. 1 acquires power, which is stored in the power storage element group 40 via the switching circuit 60, in the PLP process, and supplies the acquired power to each of the components (for example, the controller 10, the nonvolatile memory 20, and the volatile memory 70) of the memory system 1.

The power supply management circuit 30 includes a constant current circuit 31, a measurement circuit 32, a timer circuit 33, a latch circuit 34, and a step-up/down circuit 35. The controller 10 includes a calculation circuit 11. A function of the calculation circuit 11 may be implemented as the controller 10 executing a program.

The constant current circuit 31 is capable of drawing a constant current Ic from the power storage element group 40. The constant current circuit 31 extracts an electric charge at the constant current Ic from the power storage element group 40. In other words, extracting an electric charge at the constant current Ic means extracting electrons at a constant current or at a constant quantity of electric charge per unit time, or reducing the quantity of stored electric charge.

The measurement circuit 32 measures the number of times of charge/discharge N each of the power storage elements 41 to 44 has experienced. The measurement circuit 32 measures a parameter related to capacitance of the power storage element group 40 via the switching circuit 60. The measurement circuit 32 is connectable to the power storage elements 41 to 44 via the switches 61 to 64, respectively, corresponding to the plurality of power storage elements 41 to 44, respectively, in the power storage element group 40. The measurement circuit 32 measures a parameter related to capacitance of each of the power storage elements connected via the switch among the plurality of power storage elements 41 to 44. The measurement circuit 32 measures the amount of change dV in the voltage (terminal voltage) across each of the power storage elements connected via the switch among the plurality of power storage elements 41 to 44. The timer circuit 33 measures a time dt during which the measurement circuit 32 measures the amount of change dV in the terminal voltage of the power storage element. The temperature sensor 80 measures an ambient temperature T when the measurement circuit 32 measures the terminal voltage of the power storage element group 40. The latch circuit 34 stores results measured by the measurement circuit 32, the timer circuit 33, and the temperature sensor 80.

The step-up/down circuit 35 controls charging and discharging of the power storage element group 40 via the switching circuit 60. The step-up/down circuit 35 is connectable to the power storage elements 41 to 44 via the switches 61 to 64, respectively, corresponding to the plurality of power storage elements 41 to 44, respectively. The step-up/down circuit 35 can step up or down the voltage of each of the power storage elements connected via the switch among the plurality of power storage elements 41 to 44. The step-up/down circuit 35 charges and discharges each of the power storage elements connected via the switch among the plurality of power storage elements 41 to 44, using power P0 received from the host HA via the interface connector 50. The step-up/down circuit 35 may charge the power storage elements 41 to 44 by stepping up the voltage according to the power P0. The step-up/down circuit 35 may discharge the power storage elements 41 to 44 by stepping down the voltage according to the power P0.

The calculation circuit 11 of the controller 10 may access the latch circuit 34 and acquire the results, which are measured by the measurement circuit 32, the timer circuit 33, and the temperature sensor 80, from the latch circuit 34. The calculation circuit 11 calculates the degree of wear-out ER of each of the power storage elements 41 to 44 using the results measured by the measurement circuit 32, the timer circuit 33, and the temperature sensor 80. As indicated in Formulas 1 to 4 below, the calculation circuit 11 may calculate degrees of wear-out ER1 to ER4 of the power storage elements 41 to 44, respectively, by obtaining a ratio of present capacitance C11 to C41 of the power storage elements 41 to 44 with respect to initial capacitance C01 to C04, respectively and adding a correction AER according to the number of times of charge/discharge N and the ambient temperature T.

$$ER 1 = C 01 / ( C 11 ) + Δ ER ( N , T ) \qquad Formula 1$$

$$ER 2 = C 02 / ( C 12 ) + Δ ER ( N , T ) \qquad Formula 2$$

$$ER 3 = C 03 / ( C 13 ) + Δ ER ( N , T ) \qquad Formula 3$$

$$ER 4 = C 04 / ( C 14 ) + Δ ER ( N , T ) \qquad Formula 4$$

A description will be given with respect to validity of the correction AER according to the number of times of charge/discharge N and the ambient temperature T.

For example, when each of the power storage elements 41 to 44 in the power storage element group 40 is a large-capacitance capacitor, the large-capacitance capacitor reaches a high temperature state, and thus a lifespan thereof is significantly shortened. Further, Jule heat is generated near an interface during charging and discharging, but a resistance value becomes greater as the temperature becomes higher, and even when the same current flows, the Jule heat becomes greater. In other words, when the capacitor is charged and discharged at high temperature, more significant wear than mere consideration of temperature is caused. It is considered that the management of the temperature during charging and discharging is effective in reducing such an effect.

The nonvolatile memory 20 may be a NAND flash memory equipped with temperature sensors. In this case, the temperature management can be performed using a temperature conversion formula using the output of the temperature sensor equipped in the NAND flash memory and the output of the temperature sensor provided outside the NAND flash memory. The calculation circuit 11 of the controller 10 may estimate the capacitor temperature by calculating the temperature using the temperature measured by the temperature sensor 80 inside the memory system 1 and the temperature conversion formula. Another method may also be used for estimating the capacitor temperature. From log results of the temperature measured by the temperature sensor 80, the correction AER according to the number of times of charge/discharge N and the ambient temperature T is added to each of Formulas 1 to 4 so as to reduce the number of times of charge/discharge of the capacitor of which temperature is expected to become higher in future, among the plurality of capacitors in the power storage element group 40 and to promote the number of times of charge/discharge of the capacitor of which temperature is expected to become lower in future. By management of the degrees of wear-out ER1 to ER4 in this way, it is possible to appropriately estimate the degree of wear-out by taking into consideration not only the degree of wear-out calculated from the present capacitance but also the future degree of wear-out.

The initial capacitance C01 to C04 of each of the power storage elements 41 to 44 can be acquired experimentally, respectively, and set in the calculation circuit 11 in advance.

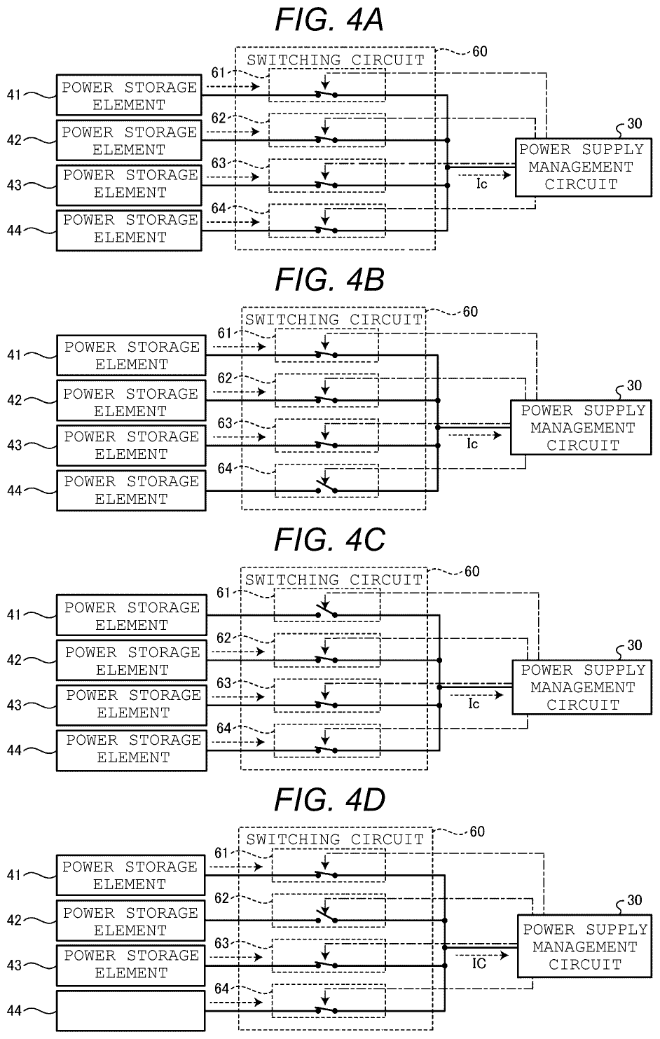

The present capacitance of each of the power storage elements 41 to 44 can be measured in a manner that the power supply management circuit 30 controls the switching circuit 60 to extract charges at the constant current Ic from at least some of the power storage elements 41 to 44, as illustrated in FIGS. 4A to 4D. FIGS. 4A to 4D are circuit diagrams illustrating the operation of the switching circuit 60 during capacitance measurement, respectively.

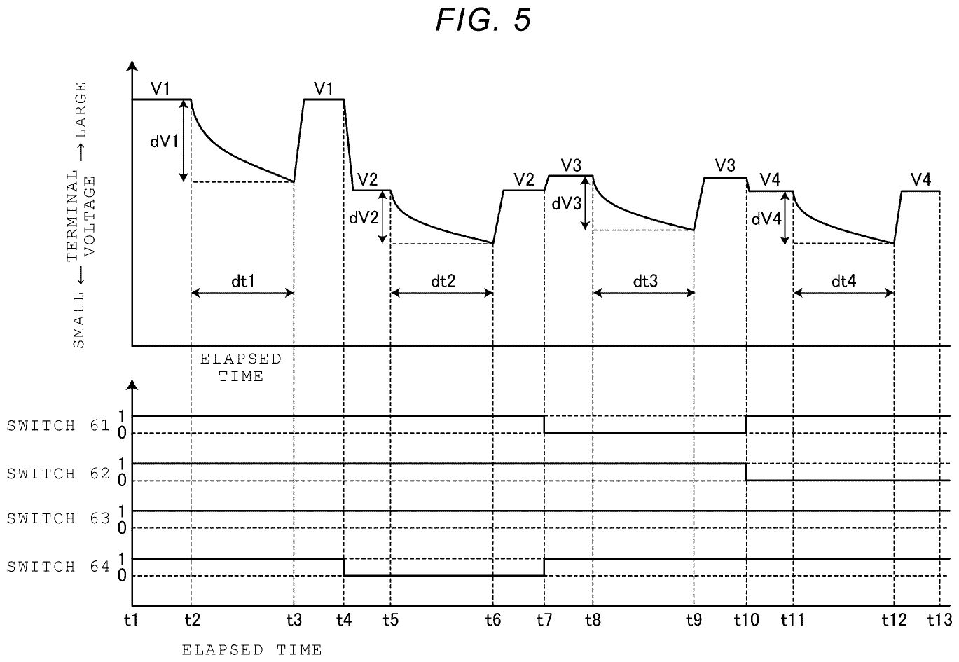

As illustrated in FIG. 4A, the power supply management circuit 30 maintains all the switches 61 to 64 in the switching circuit 60 in an ON state. Thus, the power supply management circuit 30 can measure parameters required for calculating the total of the present capacitance C11 to C14 of all the power storage elements 41 to 44 in the power storage element group 40, as illustrated in FIG. 5. FIG. 5 is a waveform diagram illustrating the operation of the switching circuit 60 and the power supply management circuit 30. In FIG. 5, the state of each of the switches 61 to 64 is indicated as 1 when being in an ON state, and 0 when being in an OFF state.

At timing t1, the switching circuit 60 turns on all of the switches 61 to 64 under control of the power supply management circuit 30. The power supply management circuit 30 charges all of the power storage elements 41 to 44 in the power storage element group 40 at a voltage V1.

At timing t2, the power supply management circuit 30 starts to draw the constant current Ic, by extracting charges at the constant current Ic from the power storage elements 41 to 44. At the same time, the power supply management circuit 30 actuates the timer circuit 33 to start counting a time.

At timing t3, the power supply management circuit 30 stops drawing the constant current Ic, stops counting the time, and measures a voltage step-down amount dV1 of the power storage elements 41 to 44. The power supply management circuit 30 acquires a counted time dt1 from the timer circuit 33. The power supply management circuit 30 charges each of the power storage elements 41 to 44 at the voltage V1, and acquires and increments the number of times of charge/discharge N stored in the latch circuit 34. The power supply management circuit 30 acquires the ambient temperature T from the temperature sensor 80. The power supply management circuit 30 stores the voltage step-down amount dV1, the time dt1, the number of times of charge/discharge N, and the ambient temperature T in the latch circuit 34 and supplies these kinds of information to the controller 10.

The calculation circuit 11 of the controller 10 may calculate the total of the present capacitance C11 to C14 of the power storage elements 41 to 44 as indicated in Formula 5 below.

$$C 11 + C 12 + C 13 + C 14 = Ic \times ( dt 1 ) / ( dV 1 ) \qquad Formula 5$$

From the timing t1 until just before timing t4, the switching circuit 60 maintains all of the switches 61 to 64 in an ON state (1 in FIG. 5).

As illustrated in FIG. 4B, the power supply management circuit 30 maintains the switch 64 in the switching circuit 60 in an OFF state, and maintains the remaining switches 61 to 63 in an ON state. Thus, the power supply management circuit 30 can measure parameters required for calculating the total of the present capacitance C11 to C13 of the power storage elements 41 to 43 in the power storage element group 40, as illustrated in FIG. 5.

At the timing t4, the switching circuit 60 switches the switch 64 to an OFF state (0 in FIG. 5) and maintains the switches 61 to 63 in an ON state under control of the power supply management circuit 30. The power supply management circuit 30 charges the power storage elements 41 to 43 in the power storage element group 40 at a voltage V2.

At timing t5, the power supply management circuit 30 starts to draw the constant current Ic, by extracting charges at the constant current Ic from the power storage elements 41 to 43. At the same time, the power supply management circuit 30 actuates the timer circuit 33 to start counting a time.

At timing t6, the power supply management circuit 30 stops drawing the constant current Ic, stops counting the time, and measures a voltage step-down amount dV2 of the power storage elements 41 to 43. The power supply management circuit 30 acquires a counted time dt2 from the timer circuit 33. The power supply management circuit 30 charges each of the power storage elements 41 to 43 at the voltage V2, and acquires and increments the number of times of charge/discharge N stored in the latch circuit 34. The power supply management circuit 30 acquires the ambient temperature T from the temperature sensor 80. The power supply management circuit 30 stores the voltage step-down amount dV2, the time dt2, the number of times of charge/discharge N, and the ambient temperature T in the latch circuit 34 and supplies these kinds of information to the controller 10.

The calculation circuit 11 of the controller 10 may calculate the total of the present capacitance C11 to C13 of the power storage elements 41 to 43 as indicated in Formula 6 below.

$$C 11 + C 12 + C 13 = Ic \times ( dt 2 ) / ( dV 2 ) \qquad Formula 6$$

From the timing t4 until just before timing t7, the switching circuit 60 maintains the switch 64 in an OFF state, and maintains the remaining switches 61 to 63 in an ON state.

As illustrated in FIG. 4C, the power supply management circuit 30 maintains the switch 61 in the switching circuit 60 in an OFF state, and maintains the remaining switches 62 to 64 in an ON state. Thus, the power supply management circuit 30 can measure parameters required for calculating the total of the present capacitance C12 to C14 of the power storage elements 42 to 44 in the power storage element group 40, as illustrated in FIG. 5.

At the timing t7, the switching circuit 60 switches the switch 61 to an OFF state, switches the switch 64 to an ON state, and maintains the switches 62 and 63 in an ON state under control of the power supply management circuit 30. The power supply management circuit 30 charges the power storage elements 42 to 44 in the power storage element group 40 at a voltage V3.

At timing t8, the power supply management circuit 30 starts to draw the constant current Ic, by extracting charges at the constant current Ic from the power storage elements 42 to 44. At the same time, the power supply management circuit 30 actuates the timer circuit 33 to start counting a time.

At timing t9, the power supply management circuit 30 stops drawing the constant current Ic, stops counting the time, and measures a voltage step-down amount dV3 of the power storage elements 42 to 44. The power supply management circuit 30 acquires a counted time dt3 from the timer circuit 33. The power supply management circuit 30 charges each of the power storage elements 42 to 44 at the voltage V3, and acquires and increments the number of times of charge/discharge N stored in the latch circuit 34. The power supply management circuit 30 acquires the ambient temperature T from the temperature sensor 80. The power supply management circuit 30 stores the voltage step-down amount dV3, the time dt3, the number of times of charge/discharge N, and the ambient temperature T in the latch circuit 34 and supplies these kinds of information to the controller 10.

The calculation circuit 11 of the controller 10 may calculate the total of the present capacitance C12 to C14 of the power storage elements 42 to 44 as indicated in Formula 7 below.

$$C 12 + C 13 + C 14 = Ic \times ( dt 3 ) / ( dV 3 ) \qquad Formula 7$$

From the timing t7 until just before timing t10, the switching circuit 60 maintains the switch 61 in an OFF state, and maintains the remaining switches 62 to 64 in an ON state.

As illustrated in FIG. 4D, the power supply management circuit 30 maintains the switch 62 in the switching circuit 60 in an OFF state, and maintains the remaining switches 61, 63 and 64 in an ON state. Thus, the power supply management circuit 30 can measure parameters required for calculating the total of the present capacitance C11, C13 and C14 of the power storage elements 41, 43 and 44 in the power storage element group 40, as illustrated in FIG. 5.

At the timing t10, the switching circuit 60 switches the switch 62 to an OFF state, switches the switch 61 to an ON state, and maintains the switches 63 and 64 in an ON state under control of the power supply management circuit 30. The power supply management circuit 30 charges the power storage elements 41, 43 and 44 in the power storage element group 40 at a voltage V4.

At timing t11, the power supply management circuit 30 starts to draw the constant current Ic, by extracting charges at the constant current Ic from the power storage elements 41, 43 and 44. At the same time, the power supply management circuit 30 actuates the timer circuit 33 to start counting a time.

At timing t12, the power supply management circuit 30 stops drawing the constant current Ic, stops counting the time, and measures a voltage step-down amount dV4 of the power storage elements 41, 43 and 44. The power supply management circuit 30 acquires a counted time dt4 from the timer circuit 33. The power supply management circuit 30 charges each of the power storage elements 41, 43 and 44 at the voltage V4, and acquires and increments the number of times of charge/discharge N stored in the latch circuit 34. The power supply management circuit 30 acquires the ambient temperature T from the temperature sensor 80. The power supply management circuit 30 stores the voltage step-down amount dV4, the time dt4, the number of times of charge/discharge N, and the ambient temperature T in the latch circuit 34 and supplies these kinds of information to the controller 10.

The calculation circuit 11 of the controller 10 may calculate the total of the present capacitance C11, C13 and C14 of the power storage elements 41, 43 and 44 as indicated in Formula 8 below.

$$C 11 + C 13 + C 14 = Ic \times ( dt 4 ) / ( dV 4 ) \qquad Formula 8$$

From the timing t10 until just before timing t13, the switching circuit 60 maintains the switch 62 in an OFF state, and maintains the remaining switches 61, 63 and 64 in an ON state.

The calculation circuit 11 can calculate the present capacitance C11 of the power storage element 41 using Formulas 5 and 7, as indicated in Formula 9 below.

$$C 11 = Ic \times ( dt 1 ) / ( dV 1 ) - Ic \times ( dt 3 ) / ( dV 3 ) \qquad Formula 9$$

The calculation circuit 11 can calculate the present capacitance C12 of the power storage element 42 using Formulas 5 and 8, as indicated in Formula 10 below.

$$C 12 = Ic \times ( dt 1 ) / ( dV 1 ) - Ic \times ( dt 4 ) / ( dV 4 ) \qquad Formula 10$$

The calculation circuit 11 can calculate the present capacitance C13 of the power storage element 43 using Formulas 5 to 8, as indicated in Formula 11 below.

$$C 13 = Ic \times ( dt 2 ) / ( dV 2 ) + Ic \times ( dt 3 ) / ( dV 3 ) + Ic \times ( dt 4 ) / ( dV 4 ) - 2 \times + Ic \times ( dt 1 ) / ( dV 1 ) \qquad Formula 11$$

The calculation circuit 11 can calculate the present capacitance C14 of the power storage element 44 using Formulas 5 and 6, as indicated in Formula 12 below.

$$C 14 = Ic \times ( dt 1 ) / ( dV 1 ) - Ic \times ( dt 2 ) / ( dV 2 ) \qquad Formula 12$$

As illustrated in FIGS. 4 and 5, when the parameter related to the total capacitance of the plurality of power storage elements is measured, the proportion of the error in the measured value can be relatively reduced compared with a case of measuring a parameter related to the capacitance of a single power storage element, and thus measurement accuracy can be easily improved.

In addition, when the parameter related to the total capacitance of the plurality of power storage elements is measured, it is advantageous in terms of coping with an interruption of the power during measurement compared with the case of measuring the parameter related to the capacitance of the single power storage element. For example, it is assumed that, in the power storage element group 40, three quarters of the total number of power storage elements are required for the PLP process. In this case, when the power is interrupted while the power storage elements are being charged and measured one by one, it will not be possible to restore data that should be protected. In the present embodiment, however, a method is used in which the total number of power storage elements (four in FIG. 4A) are measured, and then the number of power storage elements smaller by one (three in FIGS. 4B to 4D) are measured to estimate the capacitance of each power storage element by a subtraction. Therefore, since at least three quarters of the total number of power storage elements are always prepared in a charged state, the data can be restored even when the power is interrupted during the measurement.

The calculation circuit 11 can calculate a present degree of wear-out ER1 of the power storage element 41 using Formulas 1 and 9, the initial capacitance C01 of the power storage element 41, the number of times of charge/discharge N, and the ambient temperature T. The calculation circuit 11 can calculate a present degree of wear-out ER2 of the power storage element 42 using Formulas 2 and 10, the initial capacitance C02 of the power storage element 42, the number of times of charge/discharge N, and the ambient temperature T. The calculation circuit 11 can calculate a present degree of wear-out ER3 of the power storage element 43 using Formulas 3 and 11, the initial capacitance C03 of the power storage element 43, the number of times of charge/discharge N, and the ambient temperature T. The calculation circuit 11 can calculate a present degree of wear-out ER4 of the power storage element 44 using Formulas 4 and 12, the initial capacitance C04 of the power storage element 44, the number of times of charge/discharge N, and the ambient temperature T. The calculation circuit 11 supplies the present degrees of wear-out ER1 to ER4 of the power storage elements 41 to 44 to the power supply management circuit 30.

The power supply management circuit 30 receives the present degrees of wear-out ER1 to ER4 of the power storage elements 41 to 44 from the calculation circuit 11. The number n of power storage elements required for the PLP process may be set in advance in the power supply management circuit 30. The power supply management circuit 30 may select n power storage elements having a relatively small degree of wear-out ER among the plurality of power storage elements 41 to 44 in the power storage element group 40, as the power storage elements to be used in the PLP process. The power supply management circuit 30 selectively maintains n switches in the switching circuit 60 corresponding to the n power storage elements in an ON state, and maintains the remaining switches in an OFF state.

Thus, the power supply management circuit 30 can perform the PLP process by selectively using the n power storage elements having a relatively small degree of wear-out ER among the plurality of power storage elements 41 to 44, and allow the remaining power storage elements having a relatively large degree of wear-out ER to rest. As a result, the degrees of wear-out of the plurality of power storage elements 41 to 44 in the power storage element group 40 can be leveled, and the lifespan of the power storage elements 41 to 44 in the power storage element group 40 can be generally extended long.

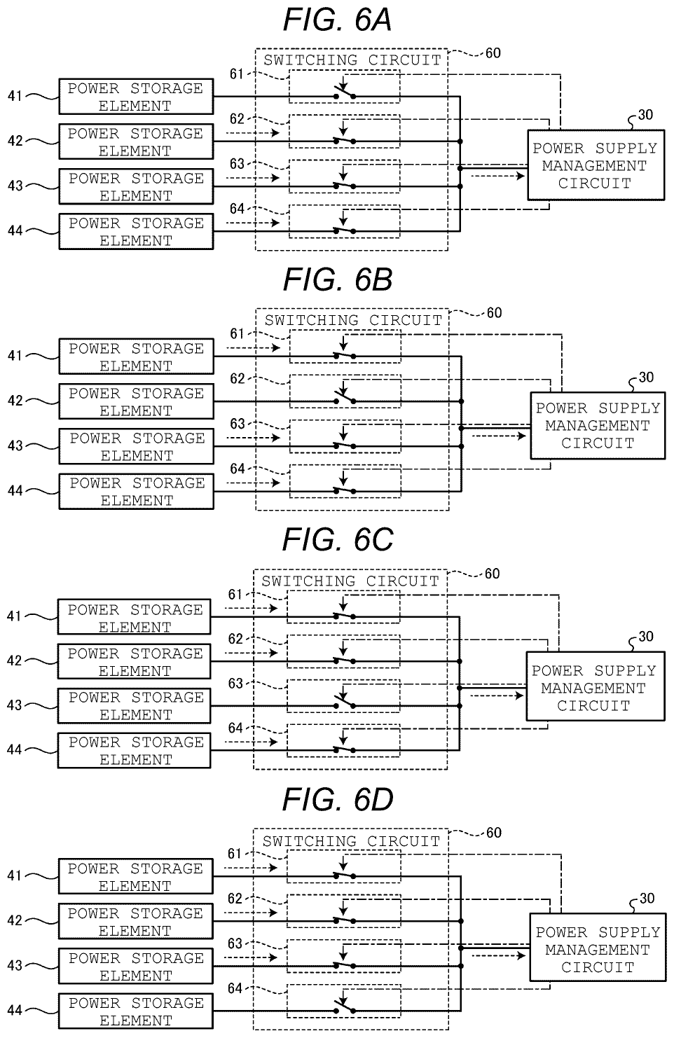

For example, when n=3 and the degree of wear-out ER1 is largest (i.e., most significantly worn out) among the present degrees of wear-out ER1 to ER4 of the power storage elements 41 to 44, the power supply management circuit 30 selects the power storage elements 42 to 44 as the power storage elements to be used for the PLP process, as illustrated in FIG. 6A. The power supply management circuit 30 maintains the switch 61 in an OFF state, and maintains the switches 62 to 64 in an ON state. Thus, the power storage elements 42 to 44 are maintained in a state of being selectively connected to the power supply terminal 30e of the power supply management circuit 30. The power supply management circuit 30 can perform the PLP process by selectively using the power storage elements 42 to 44 having a relatively small degree of wear-out ER among the plurality of power storage elements 41 to 44, and allow the remaining power storage element 41 having a relatively large degree of wear-out ER to rest.

Alternatively, when n=3 and the degree of wear-out ER2 is largest (i.e., most significantly worn out) among the present degrees of wear-out ER1 to ER4 of the power storage elements 41 to 44, the power supply management circuit 30 selects the power storage elements 41, 43 and 44 as the power storage elements to be used for the PLP process, as illustrated in FIG. 6B. The power supply management circuit 30 maintains the switch 62 in an OFF state, and maintains the switches 61, 63 and 64 in an ON state. Thus, the power storage elements 41, 43 and 44 are maintained in a state of being selectively connected to the power supply terminal 30e of the power supply management circuit 30. The power supply management circuit 30 can perform the PLP process by selectively using the power storage elements 41, 43 and 44 having a relatively small degree of wear-out ER among the plurality of power storage elements 41 to 44, and allow the power storage element 42 having a relatively large degree of wear-out ER to rest.

Alternatively, when n=3 and the degree of wear-out ER3 is largest (i.e., most significantly worn out) among the present degrees of wear-out ER1 to ER4 of the power storage elements 41 to 44, the power supply management circuit 30 selects the power storage elements 41 42 and 44 as the power storage elements to be used for the PLP process, as illustrated in FIG. 6C. The power supply management circuit 30 maintains the switch 63 in an OFF state, and maintains the switches 61, 62 and 64 in an ON state. Thus, the power storage elements 41, 42 and 44 are maintained in a state of being selectively connected to the power supply terminal 30e of the power supply management circuit 30. The power supply management circuit 30 can perform the PLP process by selectively using the power storage elements 41, 42 and 44 having a relatively small degree of wear-out ER among the plurality of power storage elements 41 to 44, and allow the power storage element 43 having a relatively large degree of wear-out ER to rest.

Alternatively, when n=3 and the degree of wear-out ER4 is largest (i.e., most significantly worn out) among the present degrees of wear-out ER1 to ER4 of the power storage elements 41 to 44, the power supply management circuit 30 selects the power storage elements 41 to 43 as the power storage elements to be used for the PLP process, as illustrated in FIG. 6D. The power supply management circuit 30 maintains the switch 64 in an OFF state, and maintains the switches 61 to 63 in an ON state. Thus, the power storage elements 41 to 43 are maintained in a state of being selectively connected to the power supply terminal 30e of the power supply management circuit 30. The power supply management circuit 30 can perform the PLP process by selectively using the power storage elements 41 to 43 having a relatively small degree of wear-out ER among the plurality of power storage elements 41 to 44, and allow the power storage element 44 having a relatively large degree of wear-out ER to rest.

As described above, according to the present embodiment, the measurement circuit 32 in the power supply management circuit 30 of the memory system 1 measures parameters related to the capacitances of the power storage elements connected via the switches 61 to 64 among the plurality of power storage elements 41 to 44. For example, the measurement circuit 32 can measure parameters related to the total capacitance of the plurality of power storage elements while partially varying the power storage elements to be measured, in order to obtain the capacitance of each of the power storage elements (see FIGS. 4A to 4D and FIG. 5). When the parameter related to the total capacitance of the plurality of power storage elements is measured, the proportion of the error in the measured value can be relatively reduced compared to the case of measuring the parameter related to the total capacitance of the single power storage element, and thus measurement accuracy can be easily improved. Therefore, the control of the plurality of power storage elements 41 to 44 can be appropriately managed.

In the present embodiment, the step-up/down circuit 35 in the power supply management circuit 30 of the memory system 1 can step up or down the voltage of each of the plurality of power storage elements 41 to 44 connected via the switches 61 to 64. For example, the step-up/down circuit 35 can step up or down the voltage of n power storage elements having a relatively small degree of wear-out ER among the plurality of power storage elements 41 to 44 (see FIGS. 6A to 6D). Thus, the power supply management circuit 30 can perform the PLP process by selectively using the n power storage elements having a relatively small degree of wear-out ER among the plurality of power storage elements 41 to 44, and allow the remaining power storage elements having a relatively large degree of wear-out ER to rest. As a result, the degrees of wear-out of the plurality of power storage elements 41 to 44 in the power storage element group 40 can be leveled, and the lifespan of the plurality of power storage elements 41 to 44 in the power storage element group 40 can be generally extended long. Therefore, the control of the plurality of power storage elements 41 to 44 can also be appropriately managed from this viewpoint.

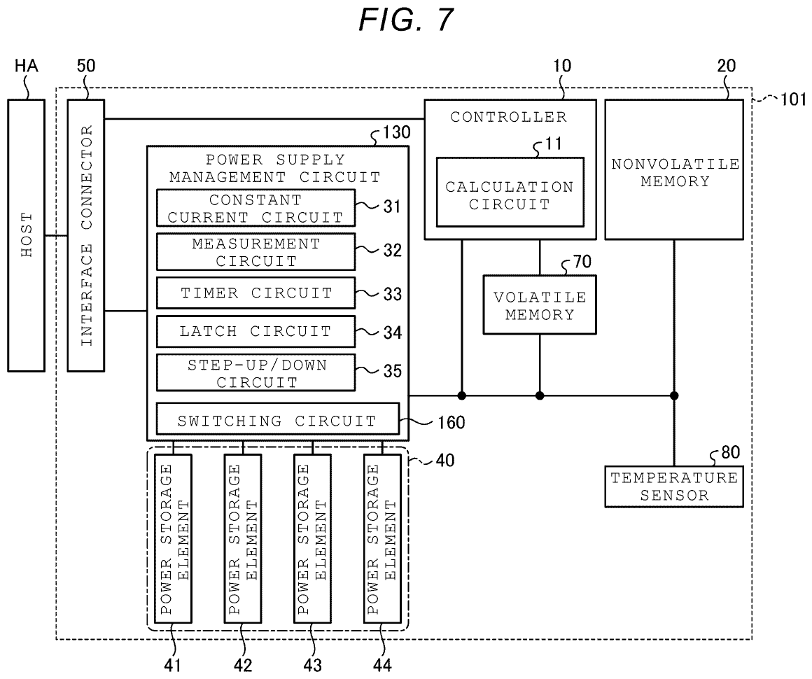

In a memory system 101 as a modification of the embodiment, a switching circuit 160 is provided in a power supply management circuit 130 as illustrated in FIG. 7. FIG. 7 is a block diagram illustrating a configuration of the memory system 101 according to the modification of the embodiment.

The switching circuit 160 is connected between other components (for example, the constant current circuit 31, the measurement circuit 32, the timer circuit 33, the latch circuit 34, and the step-up/down circuit 35) in the power supply management circuit 130 and the power storage element group 40. The switching circuit 160 functions as an interface between other components in the power supply management circuit 130 and the power storage element group 40. Under the control of the power supply management circuit 130, the switching circuit 160 is capable of connecting at least some of the plurality of power storage elements 41 to 44 in the power storage element group 40 to other components in the power supply management circuit 130.

As in the above embodiment, the switching circuit 160 includes a plurality of switches 61 to 64 (see FIG. 2). As in the above embodiment, the plurality of switches 61 to 64 may be a plurality of transistors TR1 to TR4 (see FIG. 3).

The measurement circuit 32 in the power supply management circuit 130 of such the memory system 101 also measures parameters related to capacitances of the power storage elements connected via the switches 61 to 64 among the plurality of power storage elements 41 to 44. Thus, since the parameter related to the total capacitance of the plurality of power storage elements is measured, the proportion of the error in the measured value can be relatively reduced compared to a case of measuring a parameter related to capacitance of a single power storage element, and thus measurement accuracy can be easily improved. Therefore, the control of the plurality of power storage elements 41 to 44 can be appropriately managed.

In addition, the step-up/down circuit 35 in the power supply management circuit 130 of such the memory system 101 can also step up or down the voltage of each of the plurality of power storage elements 41 to 44 connected via the switches 61 to 64. This allows the PLP process to be performed by selectively using the n power storage elements having a relatively small degree of wear-out ER among the plurality of power storage elements 41 to 44, and allows the remaining power storage elements having a relatively large degree of wear-out ER to rest. As a result, the degrees of wear-out of the plurality of power storage elements 41 to 44 in the power storage element group 40 can be leveled, and the lifespan of the plurality of power storage elements 41 to 44 in the power storage element group 40 can be generally extended long. Therefore, the control of the plurality of power storage elements 41 to 44 can also be appropriately managed from this viewpoint.

While certain embodiments have been described, these embodiments have been presented by way of example only, and are not intended to limit the scope of the disclosure. Indeed, the novel embodiments described herein may be embodied in a variety of other forms; furthermore, various omissions, substitutions, and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A power supply management circuit comprising:
a terminal connectable to a plurality of power storage elements via a plurality of switches, respectively;
a measurement circuit configured to measure a voltage of the terminal; and
a step-up/down circuit connected to the plurality of power storage elements via the terminal, wherein
the power supply management circuit is configured to:
cause a first group of the power storage elements to be in a connected state by turning on the corresponding one or more of the switches, cause the step-up/down circuit to charge the first group of the power storage elements, cause the measurement circuit to measure a first voltage difference while the first group of the power storage elements are discharged at a first constant current, and obtain a total capacity of the first group of the power storage elements based on the first constant current and the first voltage difference;
cause a second group of the power storage elements to be in a connected state by turning on the corresponding one or more of the switches, cause the step-up/down circuit to charge the second group of the power storage elements, cause the measurement circuit to measure a second voltage difference while the second group of the power storage elements are discharged at a second constant current, and obtain a total capacity of the second group of the power storage elements based on the second constant current and the second voltage difference; and
obtain a capacity of a first power storage element among the plurality of power storage elements based on a difference between the total capacity of the first group of the power storage elements and the total capacity of the second group of the power storage elements.

2. The power supply management circuit according to claim 1, wherein
the first group is all of the plurality of power storage elements, and
the second group is all of the plurality of power storage elements except one.

3. The power supply management circuit according to claim 1, wherein
each of the plurality of power storage elements is a capacitor, and
the obtained capacity of the first power storage element is a capacitance thereof.

4. The power supply management circuit according to claim 1, wherein each of the plurality of power storage elements is a battery.

5. The power supply management circuit according to claim 1, wherein
the first group of the power storage elements is charged to a first voltage, and
the second group of the power storage elements is charged to a second voltage less than the first voltage.

6. The power supply management circuit according to claim 1, wherein
the power supply management circuit is further configured to:
cause a third group of the power storage elements to be in a connected state by turning on the corresponding one or more of the switches, cause the step-up/down circuit to charge the third group of the power storage elements, cause the measurement circuit to measure a third voltage difference while the third group of the power storage elements are discharged at a third constant current, and obtain a total capacity of the third group of the power storage elements based on the third constant current and the third voltage difference; and
obtain a capacity of a second power storage element among the plurality of power storage elements based on a difference between the total capacity of the first group of the power storage elements and the total capacity of the third group of the power storage elements.

7. The power supply management circuit according to claim 6, wherein
the first group of the power storage elements is charged to a first voltage, and
the second group of the power storage elements is charged to a second voltage less than the first voltage,
the third group of the power storage elements is charged to a third voltage less than the first voltage and different from the second voltage.

8. The power supply management circuit according to claim 6, wherein
the power supply management circuit is further configured to:
cause a fourth group of the power storage elements to be in a connected state by turning on the corresponding one or more of the switches, cause the step-up/down circuit to charge the fourth group of the power storage elements, cause the measurement circuit to measure a fourth voltage difference while the fourth group of the power storage elements are discharged at a fourth constant current, and obtain a total capacity of the fourth group of the power storage elements based on the fourth constant current and the fourth voltage difference; and
obtain a capacity of a third power storage element among the plurality of power storage elements based on a difference between the total capacity of the first group of the power storage elements and the total capacity of the fourth group of the power storage elements.

9. The power supply management circuit according to claim 1, further comprising:
a temperature sensor, wherein
the power supply management circuit is further configured to:
count a number of times the first power storage element has been discharged or charged; and
obtain a wear-out degree of the first power storage element, based on an initial capacity of the first power storage element, the obtained capacity of the first power storage element, the counted: number, and a temperature measured by the temperature sensor.

10. The power supply management circuit according to claim 9, wherein
the power supply management circuit is further configured to obtain the wear-out degree of the first power storage element by calculating a ratio of the initial capacity of the first power storage element divided by the obtained capacity of the first power storage element corrected with a correction coefficient corresponding to the counted number and the measured temperature.

11. The power supply management circuit according to claim 9, wherein
the power supply management circuit is further configured to:
obtain a wear-out degree of each of the plurality of power storage elements; and
select a part, but not all, of the plurality of power storage elements to be used as a power source while an external power supply of the power supply management circuit is lost, based on the obtained wear-out degree of each of the plurality of power storage elements.

12. The power supply management circuit according to claim 11, wherein the power supply management circuit is further configured to select the part of the power storage elements to be used as the power source so as to exclude a power storage element that is most significantly worn out.

13. A memory system comprising:
the power supply management circuit according to claim 1; and
a memory connected to the power supply management circuit.

14. A power supply management circuit comprising:
a terminal connectable to a plurality of power storage elements;
a plurality of switches connected to the plurality of power storage elements via the terminal, respectively;
a measurement circuit configured to measure a voltage of the terminal; and
a step-up/down circuit connected to the plurality of power storage elements via the terminal, wherein
the power supply management circuit is configured to:
cause a first group of the power storage elements to be in a connected state by turning on the corresponding one or more of the switches, cause the step-up/down circuit to charge the first group of the power storage elements, cause the measurement circuit to measure a first voltage difference while the first group of the power storage elements are discharged at a first constant current, and obtain a total capacity of the first group of the power storage elements based on the first constant current and the first voltage difference;
cause a second group of the power storage elements to be in a connected state by turning on the corresponding one or more of the switches, cause the step-up/down circuit to charge the second group of the power storage elements, cause the measurement circuit to measure a second voltage difference while the second group of the power storage elements are discharged at a second constant current, and obtain a total capacity of the second group of the power storage elements based on the second constant current and the second voltage difference; and
obtain a capacity of a first power storage element among the plurality of power storage elements based on a difference between the total capacity of the first group of the power storage elements and the total capacity of the second group of the power storage elements.

15. The power supply management circuit according to claim 14, wherein
the first group is all of the plurality of power storage elements, and
the second group is all of the plurality of power storage elements except one.

16. The power supply management circuit according to claim 14, wherein
each of the plurality of power storage elements is a capacitor, and
the obtained capacity of the first power storage element is a capacitance thereof.

17. A memory system comprising:
the power supply management circuit according to claim 14; and
a memory connected to the power supply management circuit.

18. A power supply management method using a power supply management circuit comprising:
a terminal connectable to a plurality of power storage elements via a plurality of switches, respectively;
a measurement circuit configured to measure a voltage of the terminal; and
a step-up/down circuit connected to the plurality of power storage elements via the terminal, wherein the method comprises:
causing a first group of the power storage elements to be in a connected state by turning on the corresponding one or more of the switches, causing the step-up/down circuit to charge the first group of the power storage elements, causing the measurement circuit to measure a first voltage difference while the first group of the power storage elements are discharged at a first constant current, and obtaining a total capacity of the first group of the power storage elements based on the first constant current and the first voltage difference;
causing a second group of the power storage elements to be in a connected state by turning on the corresponding one or more of the switches, causing the step-up/down circuit to charge the second group of the power storage elements, causing the measurement circuit to measure a second voltage difference while the second group of the power storage elements are discharged at a second constant current, and obtaining a total capacity of the second group of the power storage elements based on the second constant current and the second voltage difference; and
obtaining a capacity of a first power storage element among the plurality of power storage elements based on a difference between the total capacity of the first group of the power storage elements and the total capacity of the second group of the power storage elements.

19. The power supply management method according to claim 18, wherein
the first group is all of the plurality of power storage elements, and
the second group is all of the plurality of power storage elements except one.

20. The power supply management method according to claim 18, wherein
each of the plurality of power storage elements is a capacitor, and
the obtained capacity of the first power storage element is a capacitance thereof.
